(19) United States
(12) Patent Application Publication
(10) Pub. No.: US 2014/0169295 A1
(43) Pub. Date: Jun. 19, 2014

(54) METHOD AND APPARATUS FOR CALCULATING CHANNEL QUALITY ADAPTIVELY IN MOBILE COMMUNICATION SYSTEM

(71) Applicant: Samsung Electronics Co., Ltd., Suwon-si (KR)

(72) Inventors: Kwanhee ROH, Hwaseong-si (KR); Heewon KANG, Seongnam-si (KR); Sungchan PARK, Seoul (KR); Inseok HWANG, Seoul (KR)

(73) Assignee: Samsung Electronics Co., Ltd., Suwon-si (KR)

(21) Appl. No.: 14/104,704

(22) Filed: Dec. 12, 2013

(30) Foreign Application Priority Data
Dec. 13, 2012 (KR) 10-2012-0145431

(51) Int. Cl. H04W 72/08

(52) U.S. Cl. CPC H04W 72/082
USPC 370/329

(57) ABSTRACT

A method of adaptive channel quality calculation by a User Equipment in a mobile communication system is provided. The method includes calculating a filtering coefficient indicating a length of a filtering interval according to a Carrier to Interference-plus-Noise Ratio (CINR) variation rate of each subband per unit time, and calculating a channel quality of each subband filtered according to the filtering coefficient. An environment having a large scheduling gain according to the difference in the channel quality of each subband and an environment not having as large a scheduling gain are thereby discriminated from each other in measurement of the channel quality of each subband, to apply different Infinite Impulse Response (IIR) filtering coefficient values a used for calculation of CINR of each subband.

### CROSS-REFERENCE TO RELATED APPLICATION(S)

This application claims the benefit under 35 U.S.C. §119(a) of a Korean patent application filed on Dec. 13, 2012 in the Korean Intellectual Property Office and assigned Serial number 10-2012-0145431, the entire disclosure of which is hereby incorporated by reference.

### TECHNICAL FIELD

The present disclosure relates to a method and apparatus for adaptively calculating a channel quality in a mobile communication system. More particularly, the present disclosure relates to a method and an apparatus for adaptively calculating a channel quality, in which a channel quality of each subband is calculated according to a filtering coefficient indicating the length of a filtering interval according to the Carrier to Interference-plus-Noise Ratio (CINR) variance ratio of each subband.

### BACKGROUND

In a cellular mobile communication system based on Orthogonal Frequency Division Multiple Access (OFDMA), in order to achieve a high efficiency transmission performance, the receiver side may measure the channel quality, determine information including a proper modulation scheme and a proper coding rate based on the measured channel quality, and transmit the determined information. To this end, a base station may allocate a separate feedback channel to a User Equipment (UE) or report the channel quality information to the UE through a message, etc. Since the wireless channel environment undergoes a larger channel change according to time than the wired channel environment, a transmission performance of high efficiency can be obtained when an optimum transmission scheme (a modulation scheme, a coding rate, a transmission power, etc.) can be determined at each transmission time point. To this end, a base station needs to obtain exact channel information of each UE.

In a broadband mobile communication system such as IEEE 802.16 WirelessMAN, a UE notifies a base station of channel quality information measured in the downlink through a separate dedicated feedback channel or a message, and the base station applies a modulation scheme and a coding rate suitable for the channel state by using the channel quality information received from the UE. In this event, the channel quality information measured in the downlink by the UE is quantized and mapped to a Channel Quality Indicator (CQI) value, which is periodically or non-periodically reported to the base station.

In a mobile communication system, the channel quality is influenced by not only the intensity of an interference signal transmitted from an adjacent cell but also the movement of a receiver or the change of a surrounding environment. More specifically, in the time-varying characteristics of a wireless channel, the degree of change in unit time changes according to a structural change around a UE or the movement of the UE itself Therefore, when each UE measures the channel quality, a time difference may occur between the time point at which the UE measures the quality of a downlink channel and a time point at which the transmitter actually determines the transmission scheme by using corresponding channel information. Therefore, in an environment having a large channel change per unit time, determination of a transmission scheme without considering an influence of the time-varying characteristics of a channel may be more advantageous than exact measurement of the quality of the channel.

In other words, even when a base station determines a proper modulation scheme and coding rate by using channel quality information reported by a UE and transmits a signal based on the determined modulation scheme and coding rate, the time difference between the time point of measurement of the channel quality and the time point of actual transmission of the signal may cause a difference in the channel quality. The difference between the channel quality information measured as described above and the channel quality at the time of actual signal transmission may cause a CQI mismatch.

When a CQI mismatch occurs, the measured channel quality may be lower than the channel quality at the time of actual signal transmission, thus causing a too conservative application of the adaptive modulation scheme, or alternatively may be higher than the channel quality at the time of actual signal transmission, thus causing a too aggressive application of the adaptive modulation scheme. Neither case can exactly reflect the actual channel quality, and thus both allow occurrence of a loss in the system throughput performance. Especially, when the measured channel quality is higher than the channel quality at the time of actual signal transmission, there is an increase in the probability of error occurrence in the decoding by the receiver.

In general, a mobile communication system uses a Hybrid Automatic Repeat Request (ARQ) (HARQ) scheme in order to prevent the loss of packets and a resultant performance degradation due to the use of an incorrect CQI value. However, the HARQ retransmission scheme refers to a technique of enhancing the reliability of a transmission signal by using additional radio resources (frequency and time resources) in response to the occurrence of a decoding error, instead of reducing the CQI mismatch itself Therefore, as the CQI mismatch increases, the HARQ retransmission scheme may increase the quantity of radio resources necessary for the retransmission, which subsequently causes the resultant performance degradation.

Therefore, in order to reduce the performance degradation caused by the CQI mismatch, a scheme for reducing the mismatch itself is necessary. To this end, it is usual that, instead of determining an instantaneous channel quality value at a particular time point for measurement, an average value during a predetermined time interval or an Infinite Impulse Response (IIR) filtering technique is used in order to obtain the channel quality.

Equation (1) below corresponds to the calculation of a CQI using both instantaneous channel quality information at the current time point and past channel quality information by the IIR filtering.

$$CQI ( n ) = CQI ( n - 1 ) \text{?} + CINR ( n ) / α \\ \text{?} \text{indicates text missing or illegible when filed} \qquad Equation ( 1 )$$

In Equation (1), CQI(n) indicates a CQI value at the time point n, and a indicates the length of the IIR filtering interval and has a value larger than or equal to 1. Further, Carrier to Interference-plus-Noise Ratio (CINR)(n) indicates an instantaneous channel quality value at the time point n. Here, even when there is a large change in the CINR(n) value corresponding to the instantaneous channel quality at the time point n, the size of the change of the CQI(n) value becomes smaller as the value of α becomes larger, and is thus insensitive to the change of the instantaneous channel. In contrast, as the value of α becomes smaller, the change of the CQI(n) value becomes more sensitive to the change of the CINR(n) value.

In the case of a mobile communication system such as an OFDMA system, a frequency selective fading may allow individual frequency bands to have different channel qualities. Recently developed mobile communication systems, such as an IEEE 802.16 WirelessMAN system and a 3^{rd} Generation Partnership Project (3GPP) Long Term Evolution (LTE) system, support a subband scheduling, which allows an individual UE to transmit a signal through a frequency band preferred by the individual UE. For the subband scheduling as described above, the transmitter is required to know the CQI information and information about the subband preferred by each UE. Therefore, each UE measures CQI information of each subband and reports the measured information to the base station. Equation (2) below corresponds to a calculation scheme for reducing the influence by the CQI mismatch by applying an IIR filtering specific to each subband to measurement of CQI information of each subband.

$$CQI ( \text{?} , n ) = CQI ( \text{?} , n - 1 ) \text{?} + CINR ( \text{?} , n ) / α \\ \text{?} \text{indicates text missing or illegible when filed} \qquad Equation ( 2 )$$

The calculation of CQI information for each subband by a UE as in Equation (2) above can reduce the CINR change according to the time-varying characteristics of the channel for each subband and thus can reduce, to a certain degree, the downlink throughput performance degradation according to the CQI mismatch generated by the time delay of the CQI information. However, when the value of α is unnecessarily large, the CQI information of each subband contains more previous channel quality information than current channel quality information, which results in the occurrence of a situation in which the subband (having a better quality) preferred based on the instantaneous channel and the subband preferred based on the filtered CQI information are different from each other.

For example, based on an assumption that the quality of subband B is better than the quality of subband A up to the time point (n−1), but is worse than the quality of subband A after the time point n, the quality of subband A is better than that of subband B based on the CINR(i,n) value while the quality of subband B is better than that of subband A based on the CQI(i,n) value in which the channel quality information of a past predetermined time interval is reflected according to the value of α. That is, the opportunity capable of the gain of subband selection by the difference of channel quality between the subbands is missed.

FIG. 1 is a graph illustrating a case of differently recognizing preferred subbands and CINR values of respective subbands based on α values for adjusting the length of the filtering interval in calculation of CINRs of subbands according to the related art.

Referring to FIG. 1, in view of the instantaneous channel where α=1, the CINR of subband B becomes better than the CINR of subband A from the time point T1 where the values for subband A and subband B cross on the graph. However, the CINR of subband B is recognized as better than the CINR of subband A from the time point T2 where the values for subband A and subband B cross on the graph in the case where α=4, and the CINR of subband B is recognized as better than the CINR of subband A from the time point T3 where the values for subband A and subband B cross on the graph in the case where α=16.

In general, the subband scheduling technique allows allocation of a subband having a better channel quality to each UE, so as to achieve a subband selection gain. Moreover, when there are multiple users and individual UEs prefer different subbands, the subband scheduling technique can achieve a larger multi-user diversity gain than the wideband scheme. In the subband scheduling as described above, the larger the difference between a subband having a good channel quality and a subband not having the good channel quality, the more advantageous it is in obtaining the larger gain.

Meanwhile, the subband scheduling has a smaller frequency diversity than the wideband scheme and thus has a larger time-dependent change in the channel quality by the frequency selective fading. Therefore, in an environment having a large channel change according to time, application of the subband scheduling may have a performance degradation due to a CQI mismatch according to the time-dependent change of the channel quality, which is larger than the gain by the subband selection, thereby having an adverse effect. In such a channel environment, there is a problem in that a wideband scheme for resource allocation should be used instead of the subband scheduling or the α value of the IIR filtering should be increased to remove the change of the channel according to the fast fading in calculation of the CQI value of each subband.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problem problems and/or disadvantages and to provide at least the advantages described below. Accordingly, an aspect of the present disclosure is to provide a method and an apparatus for adaptive channel quality calculation according to an adaptive modulation scheme in which a User Equipment (UE) uses different schemes for calculation of quality information of a channel according to the channel variance rate per unit time when the quality of the channel changes according to the time and by inter-adjacent cell interference signal. That is, in the proposed method and apparatus, a UE can adaptively calculate the Channel Quality Indicator (CQI) value of each subband according to the channel environment of the UE by determining whether to select a scheme for reducing the incorrectness of the CQI value due to the time-dependent change in the channel quality or calculate CQI information by instantly reflecting the time-dependent channel quality change to obtain the gain by the subband selection.

In accordance with an aspect of the present disclosure, a method of adaptive channel quality calculation by a UE in a mobile communication system is provided. The method includes calculating a filtering coefficient indicating a length of a filtering interval according to a Carrier to Interference-plus-Noise Ratio (CINR) variation rate of each subband per unit time, and calculating a channel quality of each subband filtered according to the filtering coefficient.

In accordance with another aspect of the present disclosure, a UE apparatus for performing adaptive channel quality calculation in a mobile communication system is provided. The UE apparatus includes a controller configured to calculate a filtering coefficient indicating a length of a filtering interval according to a CINR variation rate of each subband per unit time, and to calculate a channel quality of each subband filtered according to the filtering coefficient.

In accordance with another aspect of the present disclosure, a method of adaptive channel quality calculation by a base station in a mobile communication system is provided. The method includes receiving a CINR of each subband, calculating a filtering coefficient indicating a length of a filtering interval according to a CINR variation rate of each subband per unit time, and calculating a channel quality of each subband filtered according to the filtering coefficient.

In accordance with another aspect of the present disclosure, a base station apparatus of adaptive channel quality calculation in a mobile communication system is provided. The base station apparatus includes a controller configured to receive a CINR of each subband, to calculate a filtering coefficient indicating a length of a filtering interval according to a CINR variation rate of each subband per unit time, and to calculate a channel quality of each subband filtered according to the filtering coefficient.

According to an embodiment of the present disclosure, an environment having a large scheduling gain according to the difference in the channel quality of each subband and an environment not having such a large scheduling gain are discriminated from each other in measurement of the channel quality of each subband, so as to apply different Infinite Impulse Response (IIR) filtering coefficient values a used for calculation of CINR of each subband. In an environment having a small channel variance rate per unit time, a subband scheduling gain can thus be obtained due to the channel quality difference between subbands. In contrast, in an environment having a large channel variance rate per unit time, the performance degradation due to a CQI mismatch can be reduced. As a result, the present disclosure improves the throughput performance of the system.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description in conjunction with the accompanying drawings, in which:

FIG. 1 is a graph illustrating a case of differently recognizing preferred subbands and Carrier to Interference-plus-Noise Ratio (CINR) values of subbands of respective subbands based on α values for adjusting the length of the filtering interval in calculation of CINRs of the subbands according to the related art;

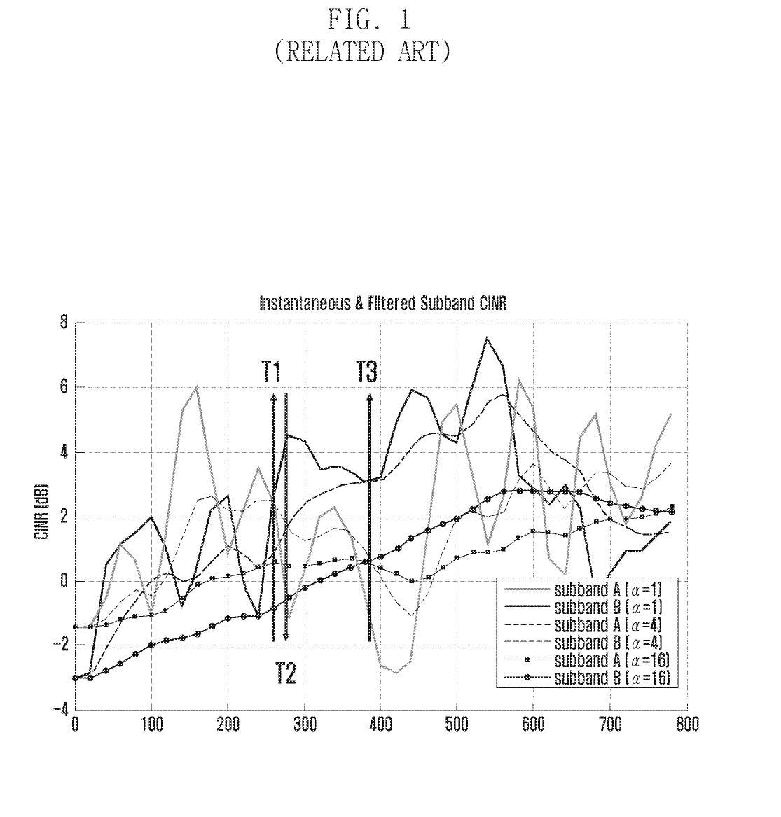

FIG. 2 is a block diagram schematically illustrating an adaptive channel quality calculation method according to an embodiment of the present disclosure;

FIG. 3 is a flowchart illustrating in more detail an adaptive channel quality calculation method according to an embodiment of the present disclosure;

FIG. 4 is a graph illustrating the distribution of CINR difference of each subband depending on a speed according to an embodiment of the present disclosure;

FIG. 5 illustrates a table used in a method for determining the value of α corresponding to the range of the channel variance rate according to an embodiment of the present disclosure; and

FIG. 6 is a block diagram illustrating the internal construction of a User Equipment (UE) according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the various embodiments of the present disclosure, descriptions related to technical contents which are well-known in the art to which the present disclosure pertains, and are not directly associated with the present disclosure, will be omitted. Such an omission of unnecessary descriptions is intended to prevent obscuring of the main idea of the present disclosure and more clearly transfer the main idea.

By the same reasons, some elements may be exaggerated, omitted, or schematically drawn in the attached drawings. Further, the depicted size of each element does not necessarily reflect the actual size. In the drawings, identical or corresponding elements are provided with identical reference numerals.

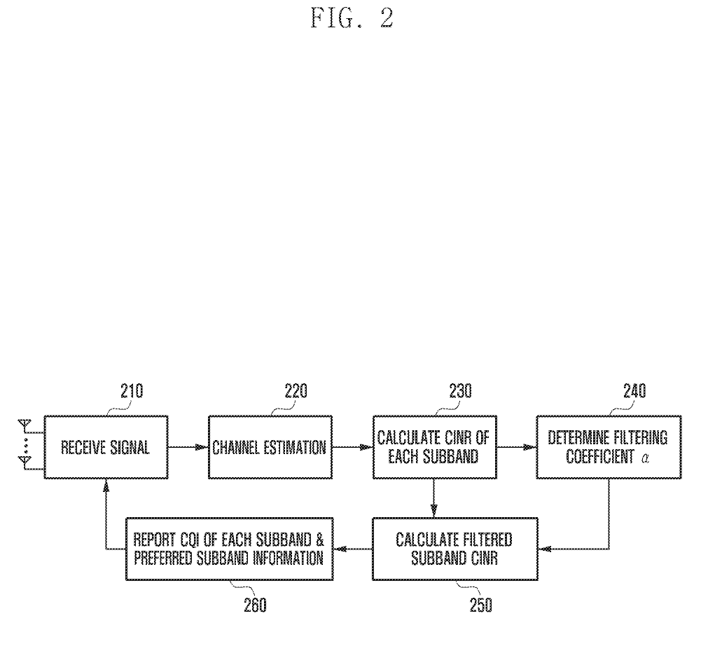

FIG. 2 is a block diagram schematically illustrating an adaptive channel quality calculation method according to an embodiment of the present disclosure.

Referring to FIG. 2, a User Equipment (UE) first receives a signal from a base station through a modem of the UE in operation 210. Then, the UE performs a channel estimation in operation 220, and calculates a Carrier to Interference-plus-Noise Ratio (CINR) value of each subband by using the estimated downlink channel in operation 230. Thereafter, in operation 240, the UE identifies the degree of change of the channel for unit time and calculates a filtering coefficient α indicating the length of the filtering interval. In operation 250, the UE calculates a filtered subband CINR (filtered CINR of each subband) by using the calculated a and CINR value of each subband. Then, in operation 260, the UE maps the calculated filtered subband CINR into CQI information and reports a CQI value of each subband and preferred subband information to the base station.

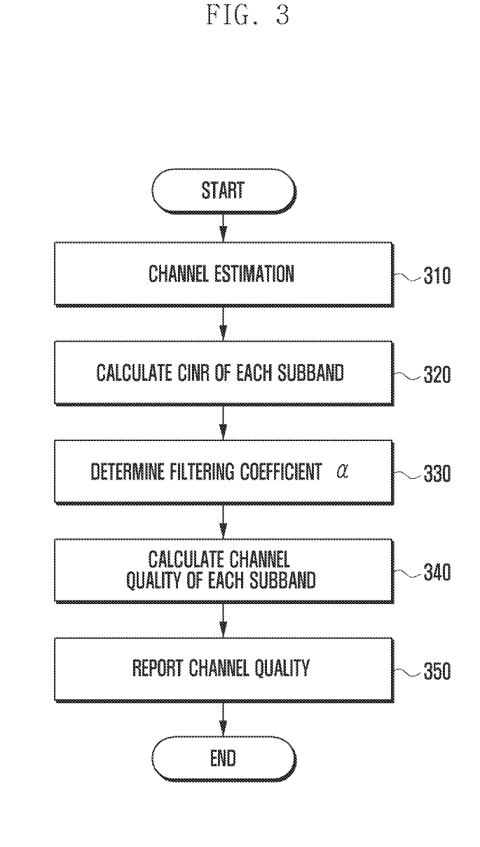

FIG. 3 is a flowchart illustrating in more detail an adaptive channel quality calculation method according to an embodiment of the present disclosure.

Referring to FIG. 3, a controller of the UE controls the UE to perform a channel estimation in operation 310. Then, in operation 320, the UE calculates a CINR value of each subband by using an estimated downlink channel obtained through the channel estimation. In this event, the CINR value of each subband may be defined as follows:

CINR_{i,n}: CINR value at the time point n of the ith subband (n=0,1,2, . . . )

In the above definition, i indicates an index of each subband, and n indicates a frame index of the time point of measurement of a channel quality which is a basis of the CINR value. For example, a CINR value at the second time point of the third subband may be expressed by CINR_{1,2}.

Thereafter, in operation 330, the controller of the UE may determine the value of the filtering coefficient α to be used for calculation of the CINR value of each subband according to the magnitude of time-dependent change of the CINR value of each subband. In this event, α indicates the length of the Infinite Impulse Response (IIR) filtering interval and has an integer value larger than or equal to 1. The smaller the value of α is, the nearer the CINR value is to the instantaneous channel quality at the time point of measurement thereof, so as to increase the gain according to the subband scheduling. In contrast, the larger the value of α is, the more the performance loss due to CQI mismatch according to the channel variation can be reduced using an average value during a predetermined time interval.

The value of α may be determined according to how much the CINR value of each subband changes at every time point where the UE measures the CINR value of each subband.

Specifically, the process of determining a may include calculating an absolute value of a difference between a CINR value of the current time point and a CINR value calculated at a previous time point for each subband, calculating an average value of the absolute values for all subbands, calculating a CINR variation rate of each subband by using the calculated average value, and determining the filtering coefficient by using the CINR variation rate of each subband.

In operation 340 a channel quality of each subband is calculated, and in operation 350 the channel quality is reported.

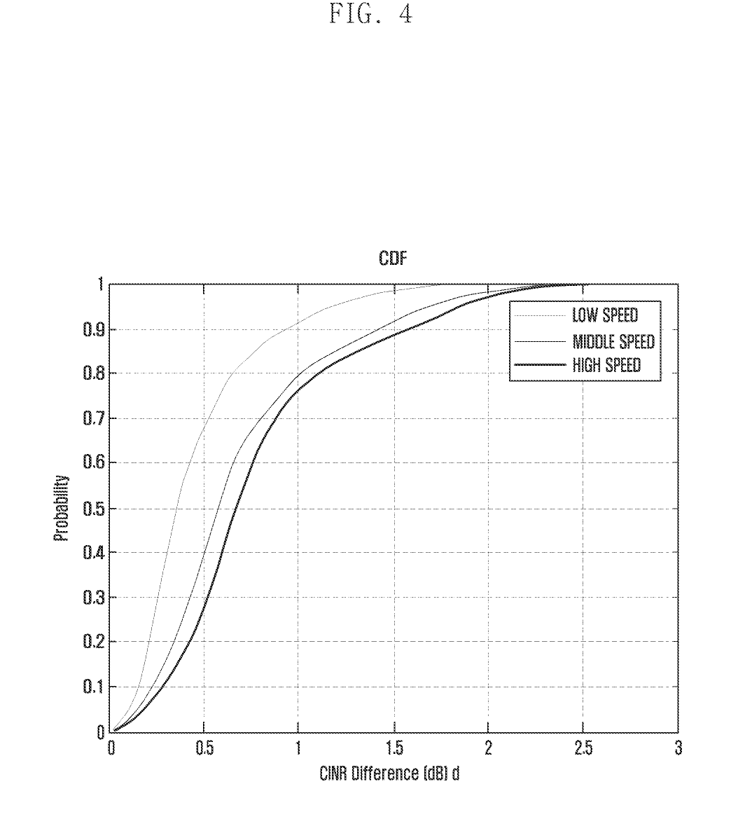

FIG. 4 is a graph illustrating the distribution of CINR difference of each subband depending on a speed according to an embodiment of the present disclosure.

FIG. 4 shows a Cumulative Distribution Function (CDF) distribution obtained through classification of quotients according to the speed of a UE wherein the quotients are obtained by dividing absolute values of differences between CINR values of subbands at a previous time point and CINR values of the subbands at a current time point by the number of all the subbands used in the calculation of the CINR, when the UE calculates a CINR of each subband at a cycle of 20 ms. As indicated in FIG. 4, as the speed of the UE increases, the CINR difference value d increases.

Herein, the quotient obtained by dividing absolute values of differences between CINR values of subbands at a previous time point and CINR values of the subbands at a current time point by the number of all the subbands used in the calculation of the CINR can be considered as an average value of the differences between the CINR values of the subbands. The average value of the differences between the CINR values of the subbands can be expressed by Equation (3) below:

$$d = \frac{1}{M} \text{?} \vert {CINR}_{i , n} - {CINR}_{i , n - 1} \vert \\ \text{?} \text{indicates text missing or illegible when filed} \qquad Equation ( 3 )$$

In Equation (3), i indicates an index of a subband, n indicates a frame index, M indicates the number of all subbands, and CINR(i,n) indicates a CINR value of the ith subband at the time point n.

As indicated in FIG. 4, the CINR difference value has a variance. Therefore, when the value of α is directly calculated using the value d obtained through Equation (3), frequent change may occur in the value of α. Therefore, the calculation may be based on a measurement of the time-dependent variance rate of the channel, so as to enhance the reliability.

Therefore, as in Equation (4) below, the IIR filtering may be applied to the value d itself to calculate an average channel variance rate according to time, that is, a CINR variance rate of each subband according to time.

$${D}_{n} = {D}_{n - 1} * \text{?} + d * \text{?} \\ \text{?} \text{indicates text missing or illegible when filed} \qquad Equation ( 4 )$$

In Equation (4), β indicates a coefficient of IIR filtering for observation of the channel variance according to time and has a value larger than or equal to 1. Experiments may be performed to find an optimum value of β.

By obtaining the time-dependent channel variance rate through Equations (3) and (4), it is possible to determine the value of α which is an IIR filtering coefficient used for calculation of a CINR of each subband according to the time-dependent channel variance rate.

The value of α may be preset based on the range of the time-dependent channel variance rate. When an interval according to the time-dependent channel variance rate and a filtering coefficient corresponding to the interval are predetermined and the calculated channel variance rate belongs to the interval, a value corresponding to the interval to which the channel variance rate belongs may be determined as a filtering coefficient.

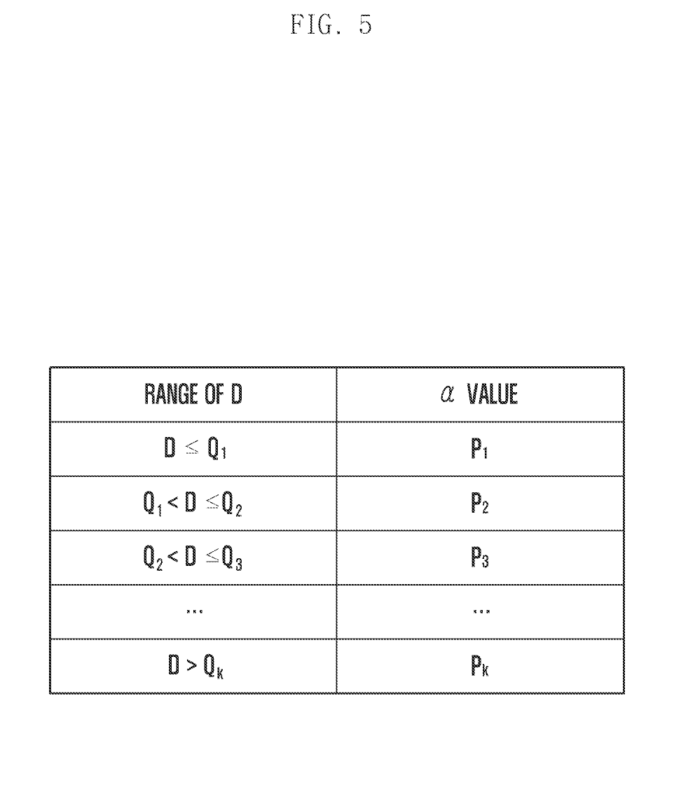

FIG. 5 illustrates a table used in a method for determining the value of α corresponding to the range of the channel variance rate according to an embodiment of the present disclosure.

Referring to FIG. 5, Q1, Q2, . . . Qk are parameters which can be optimized through experiment or by using the distribution of CINR difference according to the speed. The parameters have a correlation such that Q1<Q2< . . . <Qk. Further, P1, P2, . . . , and Pk correspond to values of a to be used in calculation of the CINR of each subband, P1=1, and P1<P2< . . . <Pk.

When the value of α is determined based on the range of the value of D shown in FIG. 5, a large D value is measured and a larger α value is thus obtained in an environment having a larger degree of channel variance. In contrast, in an environment having a smaller degree of channel variance, a smaller D value is measured and a smaller α value is thus obtained.

Therefore, in calculation of the CINR value of each subband according to an embodiment of the present disclosure, a relatively large α value is used to reflect more of the previously-measured CINR values, thereby reducing the influence of a CQI mismatch according to the channel variance, in the case where the channel variance is large. Further, in the case where the channel variance is small, a relatively small α value is used to reflect less of the previously-measured CINR values and reflect more of the newly-measured current CINR value. As a result, the present disclosure achieves more subband scheduling gain according to the channel quality difference of each subband.

Referring again to FIG. 3, in operation 340, the controller of the UE calculates the channel quality of each subband by using the filtering coefficient determined in operation 330. In this event, the controller of the UE may calculate a CQI of each subband filtered using the filtering coefficient to indicate the channel quality.

Further, the controller of the UE may report the CQI calculated in operation 340 to the base station in operation 350. Also, together with the CQI, the controller may report preferred subband information to the base station. In general, the preferred subband may be a subband having the highest quality.

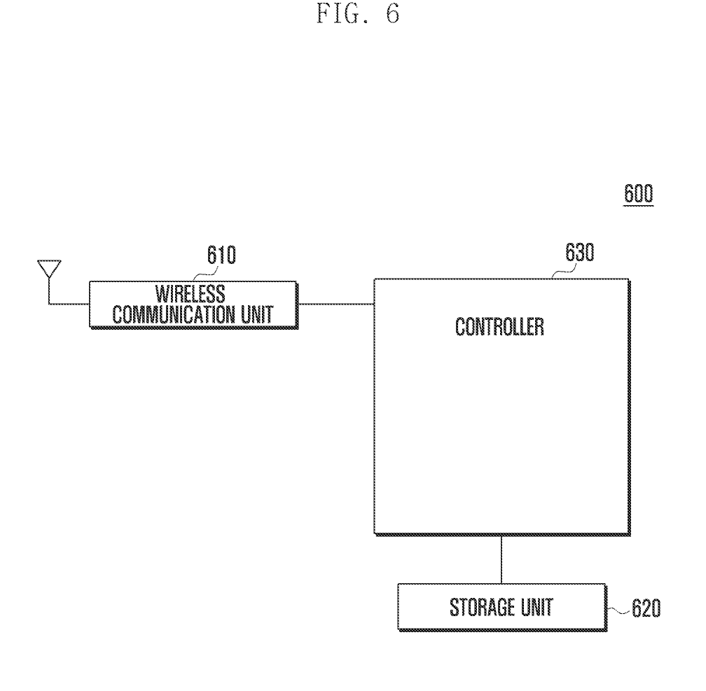

FIG. 6 is a block diagram illustrating the internal construction of a UE according to an embodiment of the present disclosure. Referring to FIG. 6, the UE 600 according to an embodiment of the present disclosure includes a wireless communication unit 610, a storage unit 620, and a controller 630.

The wireless communication unit 610 performs a communication with the base station. The UE 600 receives a signal from the base station and transmits a signal to the base station through the wireless communication unit 610. The storage unit 620 stores data generated in an operation process of the UE. Especially, the storage unit 620 stores CINRs measured at multiple time points, each of which can be used for calculation of the channel variance rate D at the next time point.

The controller 630 performs a function of controlling general operations of the UE. Especially, the controller 630 controls all procedures required for carrying out the adaptive channel quality calculation method described above.

Meanwhile, in the adaptive channel quality calculation method according to an embodiment of the present disclosure described above with reference to FIG. 3, the UE determines the value of α. However, the process of determining the value of α may alternatively be performed by the base station.

That is, the base station may receive a report of the CINR values of the subbands from the UE, determine the values of α by using the subband-specific CINR values in the same manner as in the calculation by the UE, and calculate the channel quality of each subband by applying the IIR filtering depending on a corresponding α value.

More specifically, the base station may receive a report of the subband-specific CINR values from the UE. Then, the base station may perform a process which includes calculating an absolute value of a difference between a CINR value of the current time point and a CINR value calculated at a previous time point for each subband, calculating an average value of the absolute values for all subbands, calculating a CINR variation rate of each subband by using the calculated average value, and determining the filtering coefficient by using the CINR variation rate of each subband.

The process of determining the filtering coefficient by the base station as described above corresponds to the same operation as the process of determining the filtering coefficient by the UE.

Further, according to an embodiment of the present disclosure, when the base station calculates a subband CQI value for the uplink channel of the UE, the same scheme as the operation described above may be used in the calculation of the CQI value for each uplink subband and the base station can use the calculated CQI information at the time of uplink scheduling.

That is, the base station may receive a report of CINR values for an uplink channel of the UE, determine the values of α by using the reported subband-specific CINR values in the same manner as in the above-described calculation by the UE, and then calculate the channel quality of each subband for the uplink by applying the IIR filtering depending on a corresponding α value.

The base station may also include a controller capable of performing the above-described process.

Here, it will be understood that each block of the flowchart illustrations, and combinations of blocks in the flowchart illustrations, can be implemented by computer program instructions. These computer program instructions can be stored in a computer-readable storage medium and provided to a processor of a general purpose computer, special purpose computer, or other programmable data processing apparatus to produce a machine, such that the instructions, when executed via the processor of the computer or other programmable data processing apparatus, create means for implementing the functions specified in the flowchart block or blocks. These computer program instructions may be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide operations for implementing the functions specified in the flowchart block or blocks.

Also, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” or “module” refers to a software element or a hardware element, such as a Field Programmable Gate Array (FPGA) or an Application Specific Integrated Circuit (ASIC), which performs a predetermined function. However, the unit or module does not always have a meaning limited to software or hardware. The “unit” or “module” may be constructed either to be stored in an addressable storage medium or to execute one or more processors. Therefore, the “unit” or “module” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” or “module” may be either combined into a smaller number of elements, “unit”, or “module” or divided into a larger number of elements, “unit”, or “module”. Moreover, the elements and “units” or “modules” may be implemented to reproduce one or more processors within a device or a security multimedia card.

Those skilled in the art can appreciate that it is possible to implement the present disclosure in another specific form without changing the technical idea or the indispensable characteristics of the present disclosure. Therefore, it should be understood that the above-described various embodiments are illustrative and are not limiting under any possible interpretation. The scope of the present disclosure is defined by the appended claims to be described later, rather than the detailed description. Accordingly, it should be appreciated that all modifications or variations derived from the meaning and scope of the appended claims and their equivalents are included in the range of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of adaptive channel quality calculation by a User Equipment (UE) in a mobile communication system, the method comprising:
calculating a filtering coefficient indicating a length of a filtering interval according to a Carrier to Interference-plus-Noise Ratio (CINR) variation rate of each subband per unit time; and
calculating a channel quality of each subband filtered according to the filtering coefficient.

2. The method of claim 1, wherein the calculating of the filtering coefficient comprises:
calculating a CINR of each subband;
calculating an absolute value of a difference between a CINR calculated at a previous time point and a CINR calculated at a current time point for each subband, and then calculating an average value of absolute values for all subbands;
calculating a CINR variation rate of each subband according to the calculated average value; and
determining the filtering coefficient according to the CINR variation rate of each subband.

3. The method of claim 2, wherein in the determining of the filtering coefficient by using the CINR variation rate of each subband, a predetermined filtering coefficient is determined according to a preset CINR variance rate range.

4. The method of claim 1, wherein in the calculating of the channel quality, a Channel Quality Indicator (CQI) of each subband filtered according to the filtering coefficient is calculated.

5. The method of claim 4, further comprising:
reporting preferred subband information and the filtered CQI of each subband to a base station.

6. A User Equipment (UE) apparatus for performing adaptive channel quality calculation in a mobile communication system, the UE apparatus comprising:
a controller configured to calculate a filtering coefficient indicating a length of a filtering interval according to a Carrier to Interference-plus-Noise Ratio (CINR) variation rate of each subband per unit time, and to calculate a channel quality of each subband filtered according to the filtering coefficient.

7. The UE apparatus of claim 6, wherein in the calculating of the filtering coefficient, the controller is configured to calculate a CINR of each subband, to calculate an absolute value of a difference between a CINR calculated at a previous time point and a CINR calculated at a current time point for each subband and then calculate an average value of absolute values for all subbands, to calculate a CINR variation rate of each subband according to the calculated average value, and to determine the filtering coefficient according to the CINR variation rate of each subband.

8. The UE apparatus of claim 7, wherein in the determining of the filtering coefficient by using the CINR variation rate of each subband, the controller is configured to determine a predetermined filtering coefficient according to a preset CINR variance rate range.

9. The UE apparatus of claim 6, wherein in the calculating of the channel quality, the controller is configured to calculate a Channel Quality Indicator (CQI) of each subband filtered according to the filtering coefficient.

10. The UE apparatus of claim 9, wherein the controller is configured to report preferred subband information and the filtered CQI of each subband to a base station.

11. A method of adaptive channel quality calculation by a base station in a mobile communication system, the method comprising:
receiving a Carrier to Interference-plus-Noise Ratio (CINR) of each subband;
calculating a filtering coefficient indicating a length of a filtering interval according to a CINR variation rate of each subband per unit time; and
calculating a channel quality of each subband filtered according to the filtering coefficient.

12. The method of claim 11, wherein the calculating of the filtering coefficient comprises:
calculating an absolute value of a difference between a CINR calculated at a previous time point and a CINR calculated at a current time point for each subband, and then calculating an average value of absolute values for all subbands;
calculating a CINR variation rate of each subband according to the calculated average value; and
determining the filtering coefficient according to the CINR variation rate of each subband.

13. The method of claim 12, wherein in the determining of the filtering coefficient according to the CINR variation rate of each subband, a predetermined filtering coefficient is determined according to a preset CINR variance rate range.

14. The method of claim 11, wherein in the calculating of the channel quality, a Channel Quality Indicator (CQI) of each subband filtered according to the filtering coefficient is calculated.

15. A base station apparatus of adaptive channel quality calculation in a mobile communication system, the base station apparatus comprising:
a controller configured to receive a Carrier to Interference-plus-Noise Ratio (CINR) of each subband, to calculate a filtering coefficient indicating a length of a filtering interval according to a CINR variation rate of each subband per unit time, and to calculate a channel quality of each subband filtered according to the filtering coefficient.

16. The base station apparatus of claim 15, wherein in the calculating of the filtering coefficient, the controller is configured to calculate an absolute value of a difference between a CINR calculated at a previous time point and a CINR calculated at a current time point for each subband, to calculate an average value of absolute values for all subbands, to calculate a CINR variation rate of each subband according to the calculated average value, and to determine the filtering coefficient according to the CINR variation rate of each subband.

17. The base station apparatus of claim 16, wherein in the determining of the filtering coefficient by using the CINR variation rate of each subband, the controller is configured to determine a predetermined filtering coefficient according to a preset CINR variance rate range.

18. The base station apparatus of claim 15, wherein in the calculating of the channel quality, the controller is configured to calculate a Channel Quality Indicator (CQI) of each subband filtered according to the filtering coefficient.
